(19) United States
(12) Patent Application Publication
(10) Pub. No.: US 2023/0351331 A1
(43) Pub. Date: Nov. 2, 2023

(54) INFORMATION PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Zhili YAN, Beijing (CN); Maochuan YU, Beijing (CN); Zhengyu WANG, Beijing (CN); Chenyang LI, Beijing (CN)

(21) Appl. No.: 18/141,282

(22) Filed: Apr. 28, 2023

(30) Foreign Application Priority Data
Apr. 28, 2022 (CN) 202210469619.1

(51) Int. Cl. G06Q 10/1053; G06F 9/451

(52) U.S. Cl. CPC G06Q 10/1053; G06F 9/451

(57) ABSTRACT

The present disclosure provides an information processing method and apparatus, an electronic device, and a storage medium. The information processing method includes: displaying a first control in an associated page of a first recruitment item, and determining a target person and creating a first communication group in response to a trigger operation on the first control, where the first communication group is associated with a recruitment progress of the target person in the first recruitment item; and generating a first type of notification message according to a progress event and sending the same to the first communication group, in response to generating the progress event of a recruitment process for the target person in the first recruitment item, wherein the target person is a candidate of the first recruitment item. This embodiment may facilitate follow-up of the recruitment progress of the target person.

### CROSS-REFERENCE

This application claims priority to Chinese Patent Application No. 202210469619.1, filed on Apr. 28, 2022, the disclosure of which is incorporated herein by reference in its entirety.

### TECHNICAL FIELD

The present disclosure relates to the field of computer technology, in particular to an information processing method and apparatus, an electronic device, and a storage medium.

### BACKGROUND

Enterprises recruit employees by, for example, publishing recruitment items, persons who have delivered resumes to the recruitment items become candidates, and the candidates join the enterprises as employees after links such as evaluation and interview.

### SUMMARY

The present disclosure provides an information processing method and apparatus, electronic device, and storage medium.

The following technical solutions are used in this disclosure.

In some embodiments, the present disclosure provides an information processing method, comprising:
displaying a first control in an associated page of a first recruitment item, and determining a target person and creating a first communication group in response to a trigger operation on the first control, wherein the first communication group is associated with a recruitment progress of the target person in the first recruitment item; and
generating a first type of notification message according to a progress event and sending the same to the first communication group, in response to generating the progress event of a recruitment process for the target person in the first recruitment item,
wherein, the target person is a candidate of the first recruitment item

In some embodiments, the present disclosure provides an information processing apparatus, comprising:
a creation unit, configured to display a first control in an associated page of a first recruitment item, and determine a target person and create a first communication group in response to a trigger operation on the first control, wherein the first communication group is associated with a recruitment progress of the target person in the first recruitment item; and
a control unit, configured to generate a first type of notification message according to a progress event and send the same to the first communication group, in response to generating the progress event of a recruitment process for the target person in the first recruitment item,
wherein the target person is a candidate of the first recruitment item.

In some embodiments, the present disclosure provides an electronic device, comprising: at least one memory and at least one processor,
wherein the at least one memory is configured to store program code, and the at least one processor is configured to invoke the program code stored in the at least one memory to perform the method above.

In some embodiments, the present disclosure provides a non-transitory computer-readable storage medium, wherein the computer-readable storage medium is used to store program code, and when the program code is executed by a processor, the processor is enabled to perform the method above.

In the method provided in the embodiments of the present disclosure, when a candidate in the first recruitment item is concerned, the candidate is used as the target person to create the first communication group associated with the progress event of the target person through the first control, such that the progress event of the recruitment process of the target person is sent to the first communication group in a form of the first type of notification message, and the recruitment progress of the concerned target person may be known in time, without actively asking a recruitment department the recruitment progress of the target person.

### BRIEF DESCRIPTION OF THE DRAWINGS

These and other features, advantages and aspects of embodiments of the present disclosure will become more apparent in conjunction with the accompanying drawings and with reference to the following specific embodiments. Throughout the accompanying drawings, identical or similar appended marks indicate identical or similar elements. It should be understood that the accompanying drawings are schematic and that the elements and components are not necessarily drawn to scale.

FIG. 1 is a flowchart of an information processing method according to an embodiment of the present disclosure.

FIG. 2 to FIG. 5 are schematic diagrams of a display interface according to an embodiment of the present disclosure.

FIG. 6 to FIG. 10 are schematic diagrams of a first communication group according to an embodiment of the present disclosure.

FIG. 11 is a schematic structural diagram of an electronic device according to an embodiment of the present disclosure.

### DETAILED DESCRIPTION OF PREFERRED EMBODIMENTS

Embodiments of the present disclosure will be described in greater detail below with reference to the accompanying drawings. While certain embodiments of the present disclosure are shown in the accompanying drawings, it should be understood that the present disclosure may be implemented in various forms and should not be construed as being limited to the embodiments set forth herein, but instead are provided for a more thorough and complete understanding of the present disclosure. It should be understood that the accompanying drawings and embodiments of the present disclosure are for exemplary purposes only and are not intended to limit the scope of protection of the present disclosure.

It should be understood that the individual steps documented in the method embodiments of the present disclosure may be performed in sequence and/or in parallel. In addition, the method embodiments may include additional steps and/or omit to perform the steps illustrated. The scope of the present disclosure is not limited in this regard.

The term “includes” and variations thereof as used herein are open-ended, i.e., “includes but is not limited to”. The term “based on” is “based, at least in part, on”. The term “an embodiment” means “at least one embodiment”; the term “another embodiment” means “at least one additional embodiment”; the term “some embodiment” indicates “at least some embodiments”. Definitions of other terms will be given in the description below.

It should be noted that the concepts of “first” and “second” mentioned in this disclosure are used only to distinguish between different devices, modules or units, and are not intended to define the order or interdependence of the functions performed by these devices, modules or units.

It should be noted that the modification “one” referred to in this disclosure is illustrative rather than limiting, and it should be understood by those skilled in the art to mean “one or more” unless the context clearly indicates otherwise.

The names of the messages or information interacted between the plurality of devices in this implementation of the disclosure are used for illustrative purposes only and are not intended to limit the scope of those messages or information.

The solution provided by embodiments of the present disclosure will be described in detail below in conjunction with the accompanying drawings.

During recruitment, recruitment items are often published, with recruitment positions. Interviewees submit resumes to the positions and become candidates, and then they go through the process of evaluation, interview, induction, and the like to become regular employees.

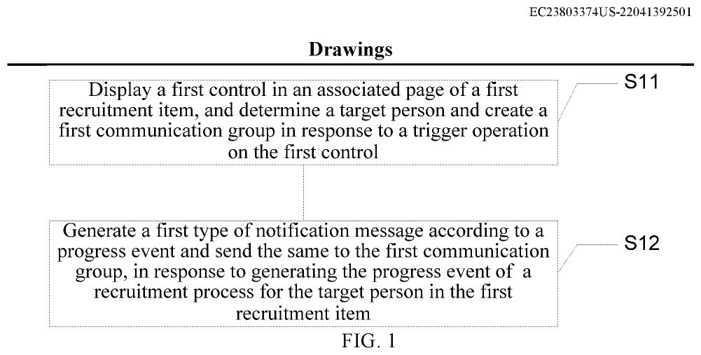

As shown in FIG. 1, FIG. 1 is a flowchart of an information processing method according to an embodiment of the present disclosure. The information processing method according to the embodiment of the present disclosure may be used for a terminal of a recruitment party, and includes the following steps.

S11: Display a first control in an associated page of a first recruitment item, and determine a target person and create a first communication group in response to a trigger operation on the first control.

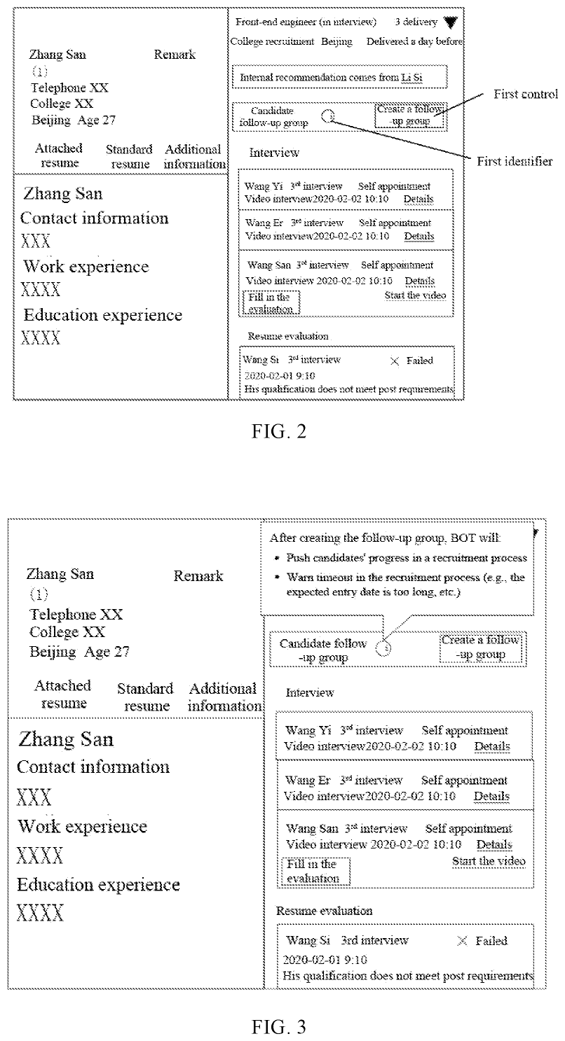

In some embodiments, the first recruitment item may refer to an item for recruiting personnel for a position. Therefore, the first recruitment item has an associated position. The position associated with the first recruitment item is a position delivered by candidates. In some embodiments, the associated page of the first recruitment item may refer to FIG. 2. The associated page of the first recruitment item may be a management page of the first recruitment item, which may display the candidates who deliver the position of the first recruitment item. In some embodiments, the candidates may be displayed in the associated page, and the target person may be a currently displayed candidate. In other embodiments, the candidates may be selected, and the target person may be, for example, a currently selected candidate. The target person is a candidate of the first recruitment item, so relevant information and a resume of the target person may be displayed in the associated page of the first recruitment item. In some embodiments, the first communication group is associated with a recruitment progress of the target person in the first recruitment item. In some embodiments, a communication client (for example, an instant messaging client) may be bound for the first recruitment item in advance, and the first communication group is created in the communication client. The first communication group is used to focus on a relevant recruitment progress of the target person in the first recruitment item, that is, a progress of a recruitment process for the target person. Members in the first communication group may not include the target person.

S12: Generate a first type of notification message according to a progress event and send the same to the first communication group, in response to generating the progress event of a recruitment process for the target person in the first recruitment item.

In some embodiments, the progress event represents a progress or update of the recruitment process for the target person in the first recruitment item, so the first type of notification message is generated according to the progress event and sent to the first communication group. The first type of notification message may include the progress event, and may also include a link to a page of the progress event, which enables the members in the first communication group to know the progress event in time. The first type of notification message may mention persons related to the progress event to remind the persons related to the progress event.

The method according to the embodiment of the present disclosure may be used for the terminal of the recruitment party. When a candidate in the first recruitment item is concerned, the candidate is used as the target person to create the first communication group associated with the progress event of the target person through the first control, such that the progress event of the recruitment process of the target person is sent to the first communication group in a form of the first type of notification message, and a person (for example, an employment manager, a department head, or the like) who concerns the target person may know the recruitment progress of the concerned target person in time, without actively asking a recruitment department the recruitment progress of the target person.

In order to better illustrate the method according to the embodiment of the present disclosure, a specific embodiment is provided below. FIG. 2 shows the associated page of the first recruitment item. The position of the first recruitment item in FIG. 2 is a front-end engineer, three candidates have delivered the position, and a candidate may be selected through, for example, a lower triangular control shown at the upper right corner of FIG. 2, where the currently selected candidate is “Zhang San”. FIG. 2 shows the first control “Create a follow-up group”. After the first control is triggered by clicking or the like, the first communication group (that is, a candidate “Zhang San” follow-up group) may be created, where the first communication group does not contain the target person “Zhang San”. After the first communication group is created, the progress event of the recruitment process of “Zhang San” is sent to the first communication group in the form of the first type of notification message, for example, for the recruitment process that Zhang San enters a second round of interview or a third round of interview, the first type of notification message is sent. In this way, a person such as a department manager who is interested in Zhang San may learn about the recruitment progress of Zhang San in the first communication group.

In some embodiments of the present disclosure, the method further includes: generating a second type of notification message according to a timeout event and sending the same to the first communication group, in response to generating the timeout event of the recruitment process for the target person in the first recruitment item.

In some embodiments, for the recruitment party, when the recruitment process for the target person has not progressed for a long time, the person who concerns the target person may get anxious and desire to know what has happened. In this case, the second type of notification message is sent to the first communication group, and the person who concerns the target person may know timeout of the recruitment process in time and then urge handlers to handle, so as to improve the work efficiency of the handlers of the recruitment process. In some embodiments, a handler of the current recruitment process may be mentioned in the second type of notification message, so as to urge the handler.

In some embodiments of the present disclosure, the displaying a first control in an associated page of a first recruitment item includes: determining whether a preset display condition is satisfied, and displaying the first control in the associated page of the first recruitment item if the preset display condition is satisfied, otherwise, hiding the first control in the associated page of the first recruitment item.

In some embodiments, the first control may be displayed only when the preset display condition is satisfied, but not when the preset display condition is not satisfied, which can avoid user experience decline caused by triggering the first control under the condition that the first communication group cannot be created.

In some embodiments of the present disclosure, the preset display condition includes at least one of the following: a current user accessing the associated page of the first recruitment item is a person who is related to the first recruitment item and has a preset function, the current user has a preset permission, the first recruitment item has candidates, and the first recruitment item is not terminated.

In some embodiments, if the current user is not related to the first recruitment item, the preset condition is not satisfied, and the first control is not displayed. If the current user is related to the first item, but does not have the preset function, the first control is also not displayed. The preset function may be a department manager, an employment manager, or the like of the position delivered by the target person. In other embodiments, whether the first control is displayed may be determined according to a permission, and the first control is displayed when the user having the preset permission views the associated page, otherwise, the first control is not displayed. In other embodiments, if the first recruitment item has no candidates, for example, no one has delivered the position provided by the first recruitment item or all persons who delivered the position have been determined not to meet requirements, the first control is not displayed, because there is no target person. In other embodiments, the first control is displayed when the first recruitment item is not terminated, otherwise the first control is hidden, because there is no progress event of the recruitment process.

In some embodiments of the present disclosure, a group type of the first communication group is displayed in an associated region of the first control. As shown in FIG. 2, a “Candidate follow-up group” (the “Candidate follow-up group” is the first communication group in some embodiments) is displayed on a left side of the first control “Create a follow-up group”, and indicates a function of the first communication group as a group type. In some embodiments, before the first communication group is created, a first identifier is displayed in the associated region of the first control, where the first identifier is used to display, after being triggered, a notification message that can be received in the first communication group. In some embodiments, as shown in FIG. 3, a circle with “i” inside is displayed on a right side of the “Candidate follow-up group” as the first identifier. The first identifier may be triggered by hovering a mouse over the first identifier, and displays content in a prompt box as shown in FIG. 3, describing information about the progress of the recruitment process for the target person that can be received in the first communication group after the first communication group is created, and a situation of recruitment process timeout, such that the function of the first communication group may be understood through the first identifier before the first communication group is created.

In some embodiments of the present disclosure, a second control is displayed in the associated page of the first recruitment item, where the second control is used to switch the target person displayed in the associated page of the first recruitment item. In some embodiments, there may be more than two candidates for the first recruitment item. In this case, the first communication group may be created for any of the candidates. The first communication group may be created for one candidate, and then the first communication group may be created for other candidates. In some embodiments, as shown in FIG. 2, the inverted triangle displayed at the upper right corner of the associated page serves as the second control, a candidate list may be displayed after the second control is triggered, the currently displayed target person may be switched by selecting a candidate in the candidate list, and relevant information of the target person displayed in the associated page is correspondingly changed to that of the selected candidate after the candidate is switched.

In some embodiments, a function description that describes a current function of the first control is displayed on the first control. In some embodiments, as shown in FIG. 2, description information “Create a follow-up group” is displayed on the first control, indicating a function of the first control. In some embodiments, person information of the target person is displayed in the associated page of the first recruitment item. In some embodiments, the person information of the target person, such as name, telephone number, and age is displayed on the left side of FIG. 2, and a resume of the target person may also be displayed, such that the current user may better know the target person, determine whether he is interested in the target person, and then determine whether the first communication group needs to be established. In some embodiments, the recruitment process for the target person is displayed in the associated page of the first recruitment item. In some embodiments, the recruitment process of interview, evaluation, and the like of the target person, and detailed information in the recruitment process are displayed on the right side of FIG. 2. The recruitment process is displayed in the associated page of the first recruitment item, such that the current user can know the current stage of the recruitment process for the target person and the performance of the target person in the recruitment process, and the current user determines whether to establish the first communication group accordingly.

In some embodiments of the present disclosure, the creating a first communication group in response to a trigger operation on the first control includes: displaying a group creation interface in response to the trigger operation on the first control, where the group creation interface displays optional members, and the optional members include related personnel of the first recruitment item; and creating the first communication group and adding selected optional members as members of the first communication group in response to a trigger operation on a third control on the group creation interface.

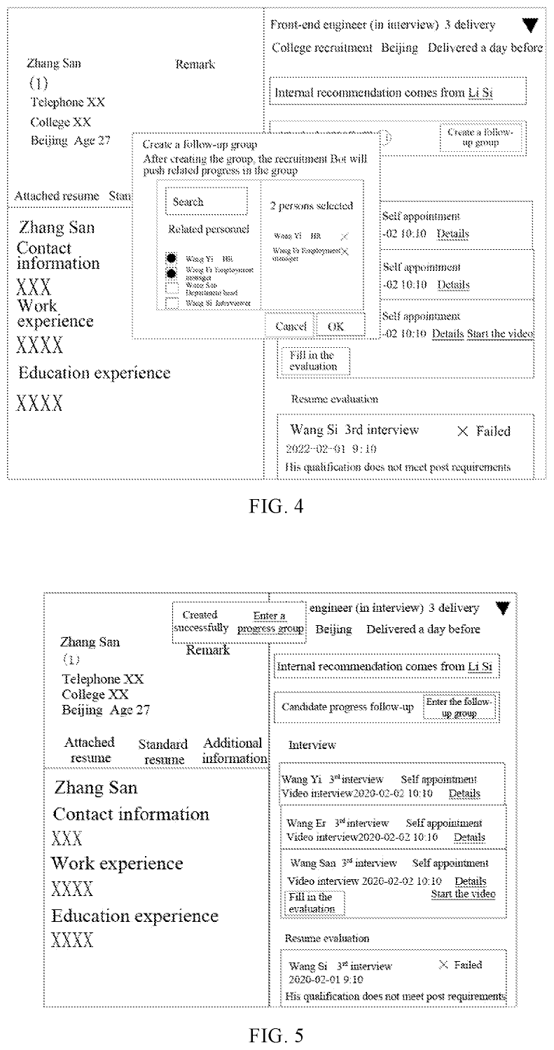

In some embodiments, after the first control is triggered by clicking or the like, the group creation interface is displayed as shown in FIG. 4, and the optional members are displayed in the group creation interface. The optional members include personnel related to the first recruitment item, which may facilitate a user to select group members. In response to a selection operation on the optional personnel, the selected optional members serve as selected members, and the selected members are added as members of the first communication group when the first communication group is created. In some embodiments, a search control may be displayed in the group creation interface, and members may be searched through the search control, so as to quickly find the members to be added. In this embodiment, the related personnel of the first recruitment item serve as optional members, so as to facilitate the addition of members of the first communication group.

In some embodiments of the present disclosure, functions of the optional members in the first recruitment item are displayed on the periphery of the optional members. In some embodiments, as shown in FIG. 4, functions such as “HR” are displayed on the right side of the optional members such as “Wang Yi”, which indicates the functions of the optional members in the first recruitment item and makes it clearer when members are added to the first communication group. In some embodiments of the present disclosure, the optional members include at least one of the following: recruiters, employment personnel, department heads, interviewers, evaluators, and assistants. In some embodiments, the current user who triggers the first control is hidden among the optional members. In some embodiments, the current user is added to the first communication group by default, so there is no need to display the current user as an optional member.

In some embodiments of the present disclosure, at least one preset person among the optional members is selected by default. In some embodiments, for example, the recruiter “HR” may be selected by default because the recruiter needs to follow up the whole recruitment process.

In some embodiments, the interviewers are ranked reversely among the optional members according to an order of interview rounds. In some embodiments, the interviewers are the ones who interview candidates, and the interviewers in later rounds of interview are probably the ones who have not started to interview the candidates, so they need to know more about the target person. Therefore, the interviewers in the later rounds of interview are displayed first, for example, the interviewers in the second round of interview are displayed before the interviewers in the first round of interview. In some embodiments, the evaluators are ranked reversely among the optional members according to a schedule. In some embodiments, similarly, the later evaluators often need to know more about the candidates, for example, the evaluators of second evaluation need to know more about the candidates than the evaluators of first evaluation. Therefore, the evaluators are ranked reversely according to the schedule of evaluation, where the schedule may be time of evaluation. In some embodiments, the assistants are ranked among the optional members according to position settings, for example, a priority may be set for each position, and the position with high priority is displayed in front of the position with low priority.

In some embodiments of the present disclosure, the information processing method further includes: after creating the first communication group, changing the function of the first control to entering the first communication group after being triggered; or changing the function of the first control and the function description displayed on the first control to entering the first communication group.

In some embodiments, as shown in FIG. 5, after the first communication group is created, because the first communication group already exists, the first communication group does not need to be created through the first control. In this case, the function of the first control changes from creating the first communication group to entering the first communication group. In some embodiments, the function description on the first control also changes accordingly.

In some embodiments of the present disclosure, after creating the first communication group, the method further includes: displaying prompt information in the associated page of the first recruitment item. As shown in FIG. 5, the prompt information “Created successfully” is displayed after the first communication group is created. In some embodiments, as shown in FIG. 5, a link “Enter a progress group” to enter the first communication group may also be displayed in the prompt information. In some embodiments, after the first communication group is created, if the first control is triggered, whether a communication client (for example, an instant messaging client) is logged in is first determined, and if so, the communication client is directly opened and the first communication group is entered, otherwise, the communication client is first called and then the first communication group is entered after the login succeeds.

In some embodiments of the present disclosure, after creating the first communication group, the method further includes: sending a group creation notification in the first communication group, where the group creation notification includes at least one of the following: a creator of the first communication group, the target person, a position delivered by the target person, a process stage at which the target person is, a function description of the first communication group, and a control for viewing details of the target person.

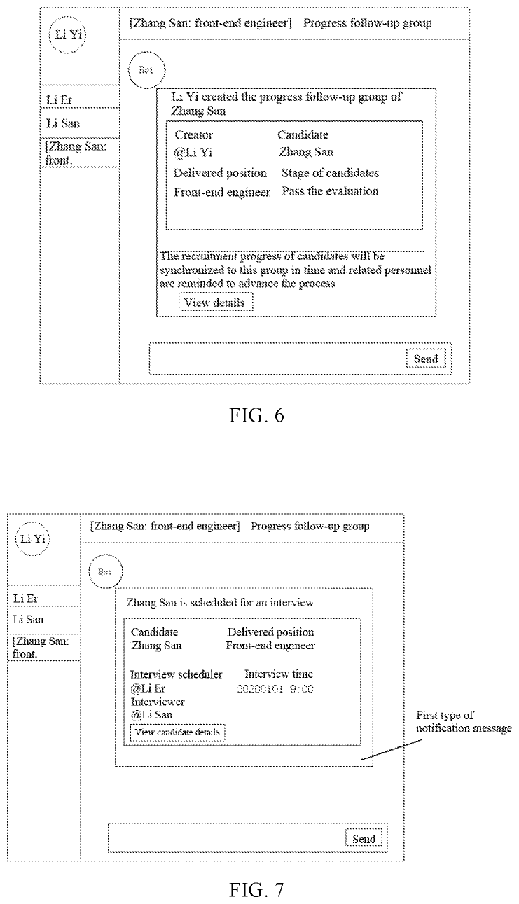

In some embodiments, as shown in FIG. 6, after the first communication group is created, the first communication group may be opened and the group creation notification may be sent to notify the first communication group created by the members of the first communication group, and the group creation notification displays the creator, the target person, the position delivered by the target person, and the stage at which the target person is, and provides the control for viewing the details of the target person. In this case, the members of the first communication group may know, through the group creation notification, brief information of the target person concerned by the first communication group, and may view the details of the target person. The page where the details of the target person are located may be the associated page of the first recruitment item, so as to view more information related to the target person. As shown in FIG. 6, the group creation notification includes the function description of the first communication group “The recruitment progress of candidates will be synchronized to this group in time and related personnel are reminded to advance the process”. Through the description information, the members who are pulled into the first communication group may know the purpose of the first communication group.

In some embodiments of the present disclosure, after the first communication group is created, the current user who triggers the first control is set as a group owner of the communication group. In some embodiments, the first communication group may be created through a chat robot. The creator of the first communication group is set as the group owner by default, and the chat robot should not be the group owner, so the current user is set as the group owner.

In some embodiments of the present disclosure, the group owner and a group administrator in the first communication group are set to be able to edit group information. In some embodiments, the group information is information that may be seen by group members, such as group notifications. The group owner and the group administrator may share information for the group members through the group information.

In some embodiments of the present disclosure, a group name of the first communication group is generated based on a name of the target person and a recruitment position of the first recruitment item. In some embodiments, the group name of the first communication group needs to be able to reflect a function of the first communication group, so the group name of the first communication group may include the name of the target person and the recruitment position of the first recruitment item.

In some embodiments of the present disclosure, generating a group name of the first communication group based on a name of the target person and a recruitment position of the first recruitment item includes: if the target person has never lost a candidate qualification before creating the first communication group, determining the group name of the first communication group according to a preset naming rule, or if the target person has ever lost a candidate qualification before creating the first communication group, determining the group name of the first communication group according to the preset rule and a number of times of the target person became a candidate; or if the target person is also a candidate of a second recruitment item and a second communication group associated with the second recruitment item exists, determining the group name of the first communication group according to a preset naming rule.

In some embodiments, when the first communication group is created for the target person for the first time, and the target person has never lost the candidate qualification, the group name may be generated according to the preset naming rule, for example, the group name may be a [target person name]: [position name] progress follow-up group, for example, “[Zhang San: front-end engineer] progress follow-up group” shown in FIG. 6. This group name indicates the target person and the delivered position, and indicates that the candidate has never lost the candidate qualification, that is, the candidate is not a candidate that has been screened out before. If the target person has ever lost the candidate qualification, it indicates that the target person may be recovered from a resume database, that is, the target person was once considered to be unsuitable for the position he delivered, but another opportunity is provided for the target person after consideration, so a number may be added after the group name generated according to the preset naming rule, and how many times the target person is recovered from the resume database is determined through the number, so as to distinguish from other candidates considered for the first time. In other embodiments, there may be a plurality of progress follow-up groups of the target person, and different progress follow-up groups follow up different recruitment items. If the target person delivers a position of a second recruitment item and becomes a candidate of the second recruitment item, the group name of the first communication group will not be affected no matter whether a second communication group (progress follow-up group) is created through a control in an associated page of the second recruitment item.

In some embodiments of the present disclosure, only one first communication group can be generated for a single delivery of the target person. After anyone creates the first communication group through the first control in the associated page of the first recruitment item, the function of the first control is changed to entering the created first communication group. This avoids creating communication groups with the same functions repeatedly.

In some embodiments of the present disclosure, if personnel mentioned in the first type of notification message are not members of the first communication group, no reminder is sent to the mentioned personnel. In some embodiments, some personnel may be mentioned in the first type of notification message. For example, when the target person is notified to be interviewed in the first type of notification message, the interviewer may be mentioned, and the way to mention personnel may be @ personnel. In some embodiments, personnel related to the progress event may be mentioned in the first type of notification message by default, and the personnel related to the progress event may not be members of the first communication group. In this case, no reminder is sent to the personnel who are not in the first communication group and are mentioned. The personnel are not in the first communication group, the first type of notification message is sent to the first communication group, and under normal circumstances, a message should only remind session members of a session where the message is located, so no reminder is sent to the personnel who are not in the first communication group to avoid cross-session notification that does not comply with permission management rules.

In some embodiments of the present disclosure, a chat robot is added when the first communication group is created, and the first type of notification message is sent through the chat robot. In some embodiments, the chat robot may be Bot shown in FIG. 7. By adding the chat robot, the chat robot automatically collects a progress event and generates a first type of notification message, which avoids a user operation. Because the chat robot is located in the first communication group, the chat robot sends the first type of notification message without breaking message sending rules.

In some embodiments of the present disclosure, a chat robot is added when the first communication group is created, and the first communication group is dissolved if the chat robot is moved out of the first communication group. In some embodiments, the first type of notification message and the second type of notification message are sent through the chat robot. When the chat robot is moved out of the first communication group, the first type of notification message and the second type of notification message cannot be sent to the first communication group. In this case, the first communication group cannot realize its function, and if the first communication group is continuously maintained, the progress follow-up group of the target person cannot be created, so the first communication group is dissolved.

In some embodiments of the present disclosure, the creating a first communication group in response to a trigger operation on the first control includes: if the first control is triggered while another user creates, through the first control, the first communication group associated with the recruitment progress of the target person in the first recruitment item, displaying second reminder information and changing the function of the first control to enter the first communication group created by the another user.

In some embodiments, special cases may occur, that is, before the first communication group is created, when the current user triggers the first control, another user also triggers the first control on its terminal, and the time when the another user triggers the first control is slightly earlier than the time when the current user triggers the first control. In this case, the current user does not need to create the first communication group. Therefore, the second reminder information is displayed to inform “the first communication group has been created”, and the function of the first control is refreshed. The function of the first control is changed to entering the first communication group created by the another user, and the function description on the first control is changed.

In some embodiments of the present disclosure, after creating the first communication group, the method further includes: in response to that the first communication group is dissolved, changing the first control back to a state of the first control before the first communication group is created. In some embodiments, when the first communication group exists, the function of the first control is to enter the first communication group, and after the first communication group is dissolved, the function of the first control is changed back to creating the first communication group.

In some embodiments of the present disclosure, after creating the first communication group, the method further includes: in response to that the first control is triggered whihle the first communication group is dissolved, displaying third reminder information to prompt that the first communication group is dissolved. In some embodiments, after the first communication group is created, the function of the first control is to enter the first communication group. When a joining user enters the first communication group through the first control, another user dissolves the first communication group. Because the first communication group does not exist, the third reminder information may be displayed to notify “the first communication group has been dissolved, please refresh and try again”.

In some embodiments of the present disclosure, the progress event of the recruitment process for the target person includes at least one of the following: an evaluation schedule for the target person in the first recruitment item, an evaluation result, an interview schedule, an interview result, an admission schedule, an admission result, a salary schedule, a salary result, feedback of the target person on admission, near entry time for the target person, entry of the target person, change of the progress stage at which the target person is, delivery transfer of the target person to another position, and delivery termination of the target person.

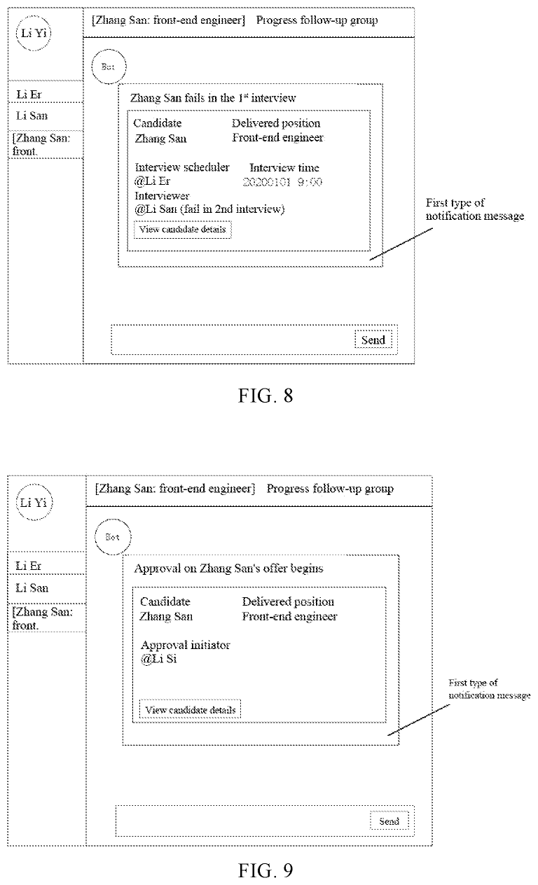

In some embodiments, the first type of notification message displays at least one of the following: a description of the progress event, associated information of the progress event, the target person, the position delivered by the target person, associated personnel of the progress event, handling results of the associated personnel on the progress event, and the control for viewing the details of the target person. In some embodiments, the recruitment process for the target person includes an evaluation stage, an interview stage, and an admission and entry stage. The interview stage is used as an example. After the target person is scheduled for an interview, the first type of notification message as shown in FIG. 7 is sent to the first communication group. It may be seen that the first type of notification message may be sent in a form of a message card, showing a description of the progress event “Zhang San is scheduled for an interview”. The message card also shows the target person, the delivered position, associated personnel (interview scheduler and interviewer) of the progress event, and a control for viewing details of candidates. In the first type of notification message, the associated personnel of the progress event may be reminded by referring to the associated personnel (for example, @ personnel). For the interview in multiple rounds, interview events of the multiple rounds of interview need to be displayed. For example, for two rounds of interview, interview time of the two rounds of interviews should be displayed in FIG. 7 respectively. The first type of notification message may display a handling result of the progress event, for example, as shown in FIG. 8. After the interview result is generated, the first type of notification message of the interview result is displayed. If the target person fails to pass the interview, the interview result is also displayed in addition to the content shown in FIG. 7. The interview result may include an interviewer's score of the target person. If there are multiple interviewers, interview results of the interviewers on the target person are displayed. When the interview is passed, the displayed first type of notification message is similar to that shown in FIG. 8, and the interview failed is changed to the interview passed.

In some embodiments, similar to the first type of notification message generated at the interview stage, if a resume evaluation is scheduled for the target person and an evaluation schedule is generated, the first type of notification message that the target person is scheduled for the resume evaluation is sent to the first communication group, which may be similar to FIG. 7, to display the target person, the delivered position, evaluation schedulers, evaluators, and a control for viewing details of the target person. Evaluation results, for example, evaluation passed and evaluation failed, are generated after the evaluation, which may also be similar to FIG. 8, to display evaluation results and scores of the evaluators.

In some embodiments, an admission schedule is initiated at the admission and entry stage, for example, offer approval is started, and the first type of notification message shown in FIG. 9 is displayed. After an admission result, such as approval passed or approval failed is generated, a similar first type of notification message is also sent, where handlers may be mentioned in the first type of notification message for next handling. After the admission is passed, a salary schedule may be carried out to determine a salary of the target person, which may also trigger the sending of the first type of notification message. The displayed first type of notification message is similar that in FIG. 9. Similarly, the first type of notification message is also sent when a salary result, such as salary approval or failure, is generated. After the salary result is generated, if the salary result is salary approval, the target person may feedback to accept or not to accept the admission, and the feedback of the target person on the admission also sends the first type of notification message. When the target person is about to enter the position (for example, the target person is about to enter the position after 14 or 7 days), the entry of the target person also sends the first type of notification message, such that the members of the first communication group know the status of the target person throughout.

In some embodiments, some other events also generate the first type of notification message in addition to the evaluation stage, the interview stage and the admission and entry stage of the handling process. For example, when the progress stage at which the target person is changes and the change of the progress stage is caused by a manual operation, and when the target person enters a new stage of the handling process, the first type of notification message is also sent. In some embodiments, the first type of notification message may be triggered when the target person is transferred from a to-be-entered stage to a stage before the to-be-entered stage, such as a back transfer stage. It should be noted that when the progress stage at which the target person is changes automatically, the first type of notification message is usually sent. Therefore, in order to avoid sending the first type of notification message repeatedly, when the progress stage change caused by a manual operation is a preset stage change below, the first type of notification message is not sent because of the progress stage change caused by the manual operation. The preset stage change includes: automatic transfer to the next stage after the evaluation stage, automatic transfer to the next stage after the interview schedule, automatic termination when a position is transferred, automatic transfer to communication of a new admission item after the new admission item is created, and entry into the entered stage. For the foregoing preset stage change, the first type of notification message has been automatically sent, so repeated sending is not required.

In some embodiments, when the delivery of the target person is transferred to another position, the first type of notification message is sent, for example, to display that the target person has transferred to another position and the current delivery is terminated. The first type of notification message may display the transferred position and mention related personnel. In some embodiments, the first type of notification message is sent when the delivery of the target person is terminated. When the delivery of the target person is terminated, a termination reason may be displayed in the first type of notification message, and specific reason content may be noted.

In some embodiments of the present disclosure, the timeout event of the recruitment process for the target person includes: no progress beyond first duration after the evaluation schedule, beyond second duration from time of the interview schedule to current time, no result beyond third duration after interview, no feedback beyond fourth duration after the admission result is generated, and staying of the target person at a preset stage for fifth duration.

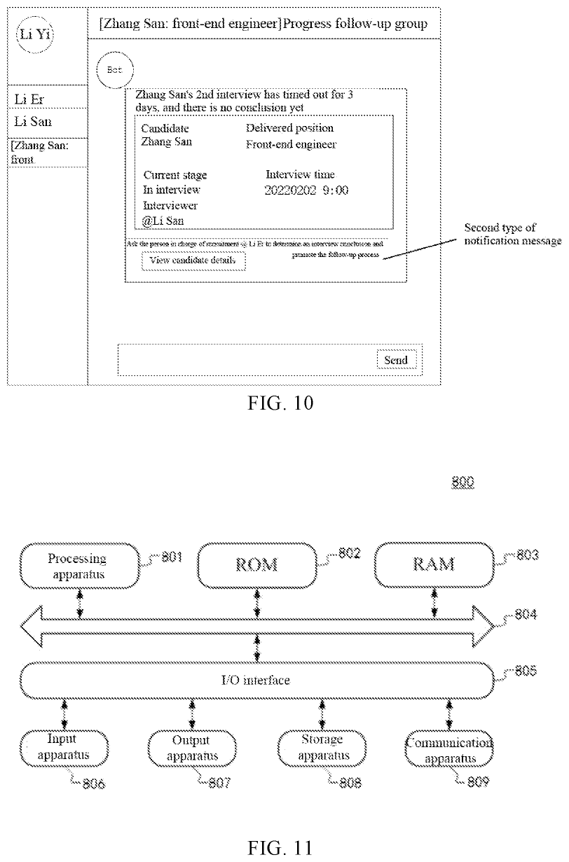

In some embodiments, the second type of notification message is prompted when there is no progress after more than 3 working days from the evaluation schedule, and if there is still no operation after the prompt, a reminder may be given every 1 working day. In some embodiments, the second type of notification message may be sent after the interview schedule succeeds but the time of the interview schedule is more than 120 hours from the current time, indicating that the interview schedule is too late. If there is no change after the notification, a reminder may be repeated every 24 hours. In some embodiments, the second type of notification message may be sent as shown in FIG. 10 when there is no interview conclusion or the interview is partially passed (partially failed or no conclusion) within 72 hours after the interview. After the prompt, if there is still no operation, a reminder is repeated every 24 hours. In some embodiments, if there is no progress within 120 hours after the admission result is generated, the second type of notification message is sent, and handlers may be mentioned. After the prompt, if there is still no operation, a reminder is repeated every 24 hours.

In some embodiments, the target person stays at the preset stage for the fifth duration, and the second type of notification message is sent. For example, the target person stops at a stage for more than 72 hours, more specifically, the timeout duration at the admission communication stage is 120 hours, and the second type of notification message may be sent. If an admission result is received during this period, the second type of notification message is not sent. After the second type of notification message is sent, if there is still no operation, a reminder is repeated every 24 hours. In some embodiments, if evaluation, interview, or the like has been scheduled at the preset stage, the second type of notification message may not be sent when the stay reaches the fifth duration. In other embodiments, if the preset stage is a to-be-entered stage, because the to-be-entered time is usually long, a timeout reminder may also not be triggered, and the second type of notification message may not be sent when the stay reaches the fifth duration.

In some embodiments, the second type of notification message displays at least one of the following: a description of the timeout event, the target person, the position delivered by the target person, related personnel of the timeout event, first reminder information mentioning handlers, and the control for viewing the details of the target person. In some embodiments, FIG. 10 may be referred to. As shown in FIG. 10, the second type of notification message displays description of the timeout event “Zhang San's 2^{nd} interview has timed out for 3 days, and there is no conclusion yet”, the target person, the delivered position, the current stage of the recruitment process (in interview), related personnel (interviewer) of timeout, first reminder information (Ask the person in charge of recruitment @ Li Er to determine an interview conclusion and promote the follow-up process), and a control for viewing the details of the target person. Through the content, the members in the first communication group may know the timeout event, and timely notify handlers for handling.

In some embodiments of the present disclosure, an information processing apparatus is further provided, including:
a creation unit, configured to display a first control in an associated page of a first recruitment item, and determine a target person and create a first communication group in response to a trigger operation on the first control, where the first communication group is associated with a recruitment progress of the target person in the first recruitment item; and
a control unit, configured to generate a first type of notification message according to the progress event and send the same to the first communication group, in response to generating the progress event of a recruitment process for the target person in the first recruitment item, wherein
the target person is a candidate of the first recruitment item.

In some embodiments, the control unit in the embodiments of the present disclosure may also be configured to perform other steps in other method embodiments except for step S11.

For embodiments of the device, which correspond essentially to the method embodiment, it is sufficient to refer to the partial description of the method embodiment where relevant. The above described embodiments of the device are only schematic, where the modules described as separate modules may or may not be separate. Some or all of these modules may be selected according to practical needs to achieve the purpose of this embodiment solution. It can be understood and implemented by a person of ordinary skill in the art without creative labor.

Above, the methods and apparatus of the present disclosure are described based on embodiments and application examples. In addition, the present disclosure provides an electronic device and a computer-readable storage medium, which are described below.

Reference is made below to FIG. 11, which illustrates a schematic diagram of the structure of an electronic device (e.g., a terminal device or a server) 800 suitable for use in implementing embodiments of the present disclosure. Terminal devices in embodiments of the present disclosure may include, but are not limited to, mobile terminals such as a cell phone, a laptop computer, a digital radio receiver, a PDA (personal digital assistant), a PAD (tablet computer), a PMP (portable multimedia player), an in-vehicle terminal (e.g., an in-vehicle navigation terminal), and the like, and a fixed terminal such as a digital TV, a desktop computer, and the like. The electronic device illustrated in the figures is only an example and should not impose any limitation on the functionality and scope of use of the embodiments of the present disclosure.

The electronic device 800 may include a processing apparatus (e.g., central processor, graphics processor, etc.) 801 that may perform various appropriate actions and processes based on programs stored in read-only memory (ROM) 802 or loaded from the storage apparatus 808 into random access memory (RAM) 803. Also stored in RANI 803 are various programs and data required for the operation of electronic device 800. The processing apparatus 801, ROM 802, and RANI 803 are connected to each other via bus 804. The input/output (I/O) interface 805 is also connected to the bus 804.

Typically, the following devices can be connected to I/O interface 805: input apparatus 806 including, for example, touch screens, touch pads, keyboards, mice, cameras, microphones, accelerometers, gyroscopes, etc.; output apparatus 807 including, for example, liquid crystal displays (LCDs), speakers, vibrators, etc.; storage apparatus 808 including, for example, magnetic tapes, hard drives, etc.; and communication apparatus 809. communication apparatus 809 may allow the electronic device 800 to communicate wirelessly or wired with other devices to exchange data. While the drawings illustrate the electronic device 800 with various devices, it should be understood that it is not required to implement or have all of the devices illustrated. More or fewer devices may alternatively be implemented or available.

In particular, according to embodiments of the present disclosure, the process described above with reference to the flowchart may be implemented as a computer software program. For example, embodiments of the present disclosure include a computer program product comprising a computer program carried on a computer readable medium, the computer program comprising program code for performing the method shown in the flowchart. In such an embodiment, the computer program may be downloaded and installed from a network via a communication apparatus 809, or from a storage apparatus 808, or from a ROM 802. When this computer program is executed by the processing apparatus 801, the above-described functions as defined in the method of this disclosed embodiment are performed.

It is to be noted that the computer-readable medium described above in this disclosure may be a computer-readable signal medium or a computer-readable storage medium or any combination of the above. The computer readable storage medium may be, for example—but not limited to—an electrical, magnetic, optical, electromagnetic, infrared, or semiconductor system, device, or device, or any combination of the above. More specific examples of computer-readable storage media may include, but are not limited to: electrically connected with one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, or any of the above. magnetic memory devices, or any suitable combination of the foregoing. In the present disclosure, a computer-readable storage medium may be any tangible medium that contains or stores a program that may be used by or in combination with an instruction execution system, device, or device. And in the present disclosure, a computer-readable signal medium may include a data signal propagated in the baseband or as part of a carrier wave that carries computer-readable program code. Such propagated data signals may take a variety of forms, including but not limited to electromagnetic signals, optical signals, or any suitable combination of the foregoing. Computer-readable signal medium can also be any computer-readable medium other than computer-readable storage media, the computer-readable signal medium can send, propagate or transmit the program for use by or in conjunction with the instruction execution system, device or device. The program code contained on the computer-readable medium may be transmitted by any suitable medium, including but not limited to: wire, fiber optic cable, RF (radio frequency), etc., or any suitable combination of the above.

In some implementations, the client, server may communicate using any currently known or future developed network protocol such as HTTP (HyperText Transfer Protocol), and may interconnect with any form or medium of digital data communication (e.g., a communication network). Examples of communication networks include local area networks (“LAN”), wide area networks (“WAN”), inter-networks (e.g., the Internet), and end-to-end networks (e.g., ad hoc end-to-end networks), as well as any currently known or future developed networks.

The above computer readable medium may be contained in the above electronic device; or it may be present separately and not assembled into the electronic device.

The above computer readable medium carries one or more programs which, when executed by the electronic device, cause the electronic device to perform the method of the present disclosure as described above.

Computer program code for performing the operations of the present disclosure may be written in one or more programming languages or combinations thereof, said programming languages including object-oriented programming languages—such as Java, Smalltalk, C++, and also including conventional procedural programming languages—such as “C” language or similar programming languages. The program code may be executed entirely on the user's computer, partially on the user's computer, as a stand-alone package, partially on the user's computer and partially on a remote computer, or entirely on a remote computer or server. In the case of a remote computer, the remote computer may be connected to the user computer over any kind of network—including a local area network (LAN) or a wide area network (WAN)—or, alternatively, may be connected to an external computer (e.g., using an Internet service provider to connect over the Internet).

The flowcharts and block diagrams in the accompanying drawings illustrate the possible implementations of the architecture, functionality, and operation of systems, methods, and computer program products in accordance with various embodiments of the present disclosure. At this point, each box in a flowchart or block diagram may represent a module, program segment, or portion of code that contains one or more executable instructions for implementing a specified logical function. It should also be noted that in some implementations as replacements, the functions indicated in the boxes may also occur in a different order than that indicated in the accompanying drawings. For example, two boxes represented one after the other can actually be executed in substantially parallel, and they can sometimes be executed in the opposite order, depending on the function involved. Note also that each box in the block diagram and/or flowchart, and the combination of boxes in the block diagram and/or flowchart, may be implemented with a dedicated hardware-based system that performs the specified function or operation, or may be implemented with a combination of dedicated hardware and computer instructions.

The units described in the embodiments of the present disclosure may be implemented by means of software, or by means of hardware. Wherein, the name of the unit does not in some cases constitute a limitation on the unit itself.

The functions described above herein may be performed, at least in part, by one or more hardware logic components. For example, non-limitingly, exemplary types of hardware logic components that may be used include: field-programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may contain or store a program for use by or in conjunction with an instruction execution system, device, or apparatus. The machine-readable medium may be a machine-readable signal medium or a machine-readable storage medium. Machine readable media may include, but are not limited to, electronic, magnetic, optical, electromagnetic, infrared, or semiconductor systems, devices, or equipment, or any suitable combination of the foregoing. More specific examples of machine-readable storage media would include one or more wire-based electrical connections, portable computer disks, hard disks, random access memory (RAM), read-only memory (ROM), erasable programmable read-only memory (EPROM or flash memory), optical fiber, convenient compact disk read-only memory (CD-ROM), optical storage devices, magnetic storage devices, or any suitable combination of the above any suitable combination of the above.

According to one or more embodiments of the present disclosure, provided an information processing method comprising:
displaying a first control in an associated page of a first recruitment item, and determining a target person and creating a first communication group in response to a trigger operation on the first control, wherein the first communication group is associated with a recruitment progress of the target person in the first recruitment item; and
generating a first type of notification message according to a progress event and sending the same to the first communication group, in response to generating the progress event of a recruitment process for the target person in the first recruitment item, wherein
the target person is a candidate of the first recruitment item.

According to one or more embodiments of the present disclosure, provided an information processing method: further comprising: generating a second type of notification message according to a timeout event and sending the same to the first communication group, in response to generating the timeout event of the recruitment process for the target person in the first recruitment item.

According to one or more embodiments of the present disclosure, provided an information processing method, wherein the displaying a first control in an associated page of a first recruitment item comprises:
determining whether a preset display condition is satisfied, and displaying the first control in the associated page of the first recruitment item if the preset display condition is satisfied, otherwise, hiding the first control in the associated page of the first recruitment item.

According to one or more embodiments of the present disclosure, provided an information processing method, wherein
the preset display condition comprises at least one of the following: a current user accessing the associated page of the first recruitment item is a person who is related to the first recruitment item and has a preset function, the current user has a preset permission, the first recruitment item has candidates, and the first recruitment item is not terminated.

According to one or more embodiments of the present disclosure, provided an information processing method, wherein at least one of the following is satisfied:
a group type of the first communication group is displayed in an associated region of the first control;
before the first communication group is created, a first identifier is displayed in the associated region of the first control, wherein the first identifier is used to display, after being triggered, a notification message that can be received in the first communication group;
a second control is displayed in the associated page of the first recruitment item, wherein the second control is used to switch the target person displayed in the associated page of the first recruitment item;
a function description that describes a current function of the first control is displayed on the first control;
person information of the target person is displayed in the associated page of the first recruitment item; and
the recruitment process for the target person is displayed in the associated page of the first recruitment item.

According to one or more embodiments of the present disclosure, provided an information processing method, wherein the creating a first communication group in response to a trigger operation on the first control comprises:
displaying a group creation interface in response to the trigger operation on the first control, wherein the group creation interface displays optional members, and the optional members comprise related personnel of the first recruitment item; and
creating the first communication group and adding selected optional members as members of the first communication group in response to a trigger operation on a third control on the group creation interface.

According to one or more embodiments of the present disclosure, provided an information processing method, wherein at least one of the following is satisfied:
functions of the optional members in the first recruitment item are displayed on the periphery of the optional members;
the optional members comprise at least one of the following: recruiters, employment personnel, department heads, interviewers, evaluators, and assistants; and
hiding the current user who triggers the first control among the optional members.

According to one or more embodiments of the present disclosure, provided an information processing method, wherein at least one of the following is satisfied:
at least one preset person among the optional members is selected by default;
the interviewers are ranked reversely among the optional members according to an order of interview rounds;
the evaluators are ranked reversely among the optional members according to a schedule; and
the assistants are ranked among the optional members according to position settings.

According to one or more embodiments of the present disclosure, provided an information processing method, further comprising:
after creating the first communication group, changing the function of the first control to entering the first communication group after being triggered; or changing the function of the first control and the function description displayed on the first control to entering the first communication group.

According to one or more embodiments of the present disclosure, provided an information processing method, wherein after creating the first communication group, the method further comprises:
sending a group creation notification in the first communication group, wherein
the group creation notification comprises at least one of the following: a creator of the first communication group, the target person, a position delivered by the target person, a process stage at which the target person is, a function description of the first communication group, and a control for viewing details of the target person.

According to one or more embodiments of the present disclosure, provided an information processing method, wherein after creating the first communication group, the method further comprises at least one of the following:
setting the current user who triggers the first control as a group owner of the communication group;
generating a group name of the first communication group based on a name of the target person and a recruitment position of the first recruitment item; and
setting the group owner and a group administrator in the first communication group to be able to edit group information.

According to one or more embodiments of the present disclosure, provided an information processing method, wherein the generating a group name of the first communication group based on a name of the target person and a recruitment position of the first recruitment item comprises:
if the target person has never lost a candidate qualification before creating the first communication group, determining the group name of the first communication group according to a preset naming rule, or
if the target person has ever lost a candidate qualification before creating the first communication group, determining the group name of the first communication group according to the preset rule and a number of times the target person became a candidate; or
if the target person is also a candidate of a second recruitment item and a second communication group associated with the recruitment progress of the target person in the second recruitment item exists, determining the group name of the first communication group according to a preset naming rule.

According to one or more embodiments of the present disclosure, provided an information processing method, further comprising at least one of the following:
if personnel mentioned in the first type of notification message are not members of the first communication group, no reminder is sent to the mentioned personnel;
adding a chat robot when the first communication group is created, and sending the first type of notification message through the chat robot;
adding a chat robot when the first communication group is created, and dissolving the first communication group if the chat robot is moved out of the first communication group.

According to one or more embodiments of the present disclosure, provided an information processing method, wherein the creating a first communication group in response to a trigger operation on the first control comprises:
if the first control is triggered while another user creates, through the first control, the first communication group associated with the recruitment progress of the target person in the first recruitment item, displaying second reminder information and changing the function of the first control to entering the first communication group created by the another user.

According to one or more embodiments of the present disclosure, provided an information processing method, wherein after creating the first communication group, the method further comprises at least one of the following:
in response to that the first communication group is dissolved, changing the first control back to a state of the first control before the first communication group is created; and
in response to that the first control is triggered while the first communication group is dissolved, displaying third reminder information to prompt that the first communication group is dissolved.

According to one or more embodiments of the present disclosure, provided an information processing method, wherein the progress event of the recruitment process for the target person comprises at least one of the following:
an evaluation schedule for the target person in the first recruitment item, an evaluation result, an interview schedule, an interview result, an admission schedule, an admission result, a salary schedule, a salary result, feedback of the target person on admission, near entry time for the target person, entry of the target person, change of the progress stage at which the target person is, delivery transfer of the target person to another position, and delivery termination of the target person.

According to one or more embodiments of the present disclosure, provided an information processing method, wherein the timeout event of the recruitment process for the target person comprises:
no progress beyond first duration after the evaluation schedule, beyond second duration from time of the interview schedule to current time, no result beyond third duration after interview, no feedback beyond fourth duration after the admission result is generated, and staying of the target person at a preset stage for fifth duration.

According to one or more embodiments of the present disclosure, provided an information processing method, wherein the first type of notification message displays at least one of the following: a description of the progress event, associated information of the progress event, the target person, the position delivered by the target person, associated personnel of the progress event, handling results of the associated personnel on the progress event, and the control for viewing the details of the target person; and/or
the second type of notification message displays at least one of the following: a description of the timeout event, the target person, the position delivered by the target person, related personnel of the timeout event, first reminder information mentioning handlers, and the control for viewing the details of the target person.

According to one or more embodiments of the present disclosure, provided an information processing apparatus, comprising:
a creation unit, configured to display a first control in an associated page of a first recruitment item, and determine a target person and create a first communication group in response to a trigger operation on the first control, wherein the first communication group is associated with a recruitment progress of the target person in the first recruitment item; and
a control unit, configured to generate a first type of notification message according to a progress event and send the same to the first communication group, in response to generating the progress event of a recruitment process for the target person in the first recruitment item, wherein
the target person is a candidate of the first recruitment item.

According to one or more embodiments of the present disclosure, provided an electronic device, comprising:
at least one memory and at least one processor, wherein
the at least one memory is configured to store program code, and the at least one processor is configured to invoke the program code stored in the at least one memory to perform the method according to any one of above.

According to one or more embodiments of the present disclosure, provided a computer-readable storage medium, wherein the computer-readable storage medium is used to store program code, and when the program code is executed by a processor, the processor is enabled to perform the method according to any one of above.

The above description is only a better embodiment of the present disclosure and a description of the technical principles applied. It should be understood by those skilled in the art that the scope of the disclosure covered by the present disclosure is not limited to technical solutions formed by specific combinations of the above technical features, but should also cover other technical solutions formed by any combination of the above technical features or their equivalent features without departing from the above disclosed idea. For example, the above features are interchangeable with (but not limited to) the technical features with similar functions disclosed in this disclosure.

Furthermore, although a specific order is used to depict the individual operations, this should not be interpreted as requiring that these operations be executed in the specific order shown or in sequential order of execution. Multitasking and parallel processing may be advantageous in certain environments. Again, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the present subject matter has been described using language specific to structural features and/or method logical actions, it should be understood that the subject matter defined in the appended claims is not necessarily limited to the particular features or actions described above. Rather, the particular features and actions described above are merely exemplary forms of claim fulfillment.

What is claimed is:

1. An information processing method, comprising:
displaying a first control in an associated page of a first recruitment item, and determining a target person and creating a first communication group in response to a trigger operation on the first control, wherein the first communication group is associated with a recruitment progress of the target person in the first recruitment item; and
generating a first type of notification message according to a progress event and sending the same to the first communication group, in response to generating the progress event of a recruitment process for the target person in the first recruitment item, wherein
the target person is a candidate of the first recruitment item.

2. The method according to claim 1, further comprising: generating a second type of notification message according to a timeout event and sending the same to the first communication group, in response to generating the timeout event of the recruitment process for the target person in the first recruitment item.

3. The method according to claim 1, wherein the displaying a first control in an associated page of a first recruitment item comprises:
determining whether a preset display condition is satisfied, and displaying the first control in the associated page of the first recruitment item if the preset display condition is satisfied, otherwise, hiding the first control in the associated page of the first recruitment item.

4. The method according to claim 3, wherein
the preset display condition comprises at least one of the following: a current user accessing the associated page of the first recruitment item is a person who is related to the first recruitment item and has a preset function, the current user has a preset permission, the first recruitment item has candidates, and the first recruitment item is not terminated.

5. The method according to claim 1, wherein at least one of the following is satisfied:
a group type of the first communication group is displayed in an associated region of the first control;
before the first communication group is created, a first identifier is displayed in the associated region of the first control, wherein the first identifier is used to display, after being triggered, a notification message that can be received in the first communication group;
a second control is displayed in the associated page of the first recruitment item, wherein the second control is used to switch the target person displayed in the associated page of the first recruitment item;
a function description that describes a current function of the first control is displayed on the first control;
person information of the target person is displayed in the associated page of the first recruitment item; and
the recruitment process for the target person is displayed in the associated page of the first recruitment item.

6. The method according to claim 1, wherein the creating a first communication group in response to a trigger operation on the first control comprises:
displaying a group creation interface in response to the trigger operation on the first control, wherein the group creation interface displays optional members, and the optional members comprise related personnel of the first recruitment item; and
creating the first communication group and adding selected optional members as members of the first communication group in response to a trigger operation on a third control on the group creation interface.

7. The method according to claim 6, wherein at least one of the following is satisfied:
functions of the optional members in the first recruitment item are displayed on the periphery of the optional members;
the optional members comprise at least one of the following: recruiters, employment personnel, department heads, interviewers, evaluators, and assistants; and
hiding the current user who triggers the first control among the optional members.

8. The method according to claim 7, wherein at least one of the following is satisfied:
at least one preset person among the optional members is selected by default;
the interviewers are ranked reversely among the optional members according to an order of interview rounds;
the evaluators are ranked reversely among the optional members according to a schedule; and
the assistants are ranked among the optional members according to position settings.

9. The method according to claim 1, further comprising:
after creating the first communication group, changing the function of the first control to entering the first communication group after being triggered; or changing the function of the first control and the function description displayed on the first control to entering the first communication group.

10. The method according to claim 1, wherein after creating the first communication group, the method further comprises:
sending a group creation notification in the first communication group, wherein
the group creation notification comprises at least one of the following: a creator of the first communication group, the target person, a position delivered by the target person, a process stage at which the target person is, a function description of the first communication group, and a control for viewing details of the target person.

11. The method according to claim 1, wherein after creating the first communication group, the method further comprises at least one of the following:
setting the current user who triggers the first control as a group owner of the communication group;
generating a group name of the first communication group based on a name of the target person and a recruitment position of the first recruitment item; and
setting the group owner and a group administrator in the first communication group to be able to edit group information.

12. The method according to claim 11, wherein the generating a group name of the first communication group based on a name of the target person and a recruitment position of the first recruitment item comprises:
if the target person has never lost a candidate qualification before creating the first communication group, determining the group name of the first communication group according to a preset naming rule, or
if the target person has ever lost a candidate qualification before creating the first communication group, determining the group name of the first communication group according to the preset rule and a number of times the target person became a candidate; or
if the target person is also a candidate of a second recruitment item and a second communication group associated with the recruitment progress of the target person in the second recruitment item exists, determining the group name of the first communication group according to a preset naming rule.

13. The method according to claim 1, further comprising at least one of the following:
if personnel mentioned in the first type of notification message are not members of the first communication group, no reminder is sent to the mentioned personnel;
adding a chat robot when the first communication group is created, and sending the first type of notification message through the chat robot;
adding a chat robot when the first communication group is created, and dissolving the first communication group if the chat robot is moved out of the first communication group.

14. The method according to claim 1, wherein the creating a first communication group in response to a trigger operation on the first control comprises:
if the first control is triggered while another user creates, through the first control, the first communication group associated with the recruitment progress of the target person in the first recruitment item, displaying second reminder information and changing the function of the first control to entering the first communication group created by the another user.

15. The method according to claim 9, wherein after creating the first communication group, the method further comprises at least one of the following:
in response to that the first communication group is dissolved, changing the first control back to a state of the first control before the first communication group is created; and
in response to that the first control is triggered while the first communication group is dissolved, displaying third reminder information to prompt that the first communication group is dissolved.

16. The method according to claim 1, wherein the progress event of the recruitment process for the target person comprises at least one of the following:
an evaluation schedule for the target person in the first recruitment item, an evaluation result, an interview schedule, an interview result, an admission schedule, an admission result, a salary schedule, a salary result, feedback of the target person on admission, near entry time for the target person, entry of the target person, change of the progress stage at which the target person is, delivery transfer of the target person to another position, and delivery termination of the target person.

17. The method according to claim 2, wherein the timeout event of the recruitment process for the target person comprises:
no progress beyond first duration after the evaluation schedule, beyond second duration from time of the interview schedule to current time, no result beyond third duration after interview, no feedback beyond fourth duration after the admission result is generated, and staying of the target person at a preset stage for fifth duration.

18. The method according to claim 1, wherein
the first type of notification message displays at least one of the following: a description of the progress event, associated information of the progress event, the target person, the position delivered by the target person, associated personnel of the progress event, handling results of the associated personnel on the progress event, and the control for viewing the details of the target person; and/or
the second type of notification message displays at least one of the following: a description of the timeout event, the target person, the position delivered by the target person, related personnel of the timeout event, first reminder information mentioning handlers, and the control for viewing the details of the target person.

19. An electronic device, comprising:
at least one memory and at least one processor, wherein
the at least one memory is configured to store program code, and the at least one processor is configured to invoke the program code stored in the at least one memory to perform an information processing method, comprising:
displaying a first control in an associated page of a first recruitment item, and determining a target person and creating a first communication group in response to a trigger operation on the first control, wherein the first communication group is associated with a recruitment progress of the target person in the first recruitment item; and
generating a first type of notification message according to a progress event and sending the same to the first communication group, in response to generating the progress event of a recruitment process for the target person in the first recruitment item, wherein the target person is a candidate of the first recruitment item.

20. A non-transitory computer-readable storage medium, wherein the computer-readable storage medium is used to store program code, and when the program code is executed by a processor, the processor is enabled to perform an information processing method, comprising:
displaying a first control in an associated page of a first recruitment item, and determining a target person and creating a first communication group in response to a trigger operation on the first control, wherein the first communication group is associated with a recruitment progress of the target person in the first recruitment item; and
generating a first type of notification message according to a progress event and sending the same to the first communication group, in response to generating the progress event of a recruitment process for the target person in the first recruitment item, wherein the target person is a candidate of the first recruitment item.
